(19) United States
(12) Patent Application Publication
(10) Pub. No.: US 2022/0105470 A1
(43) Pub. Date: Apr. 7, 2022

(54) Electromagnetic Induction Pervaporation Membrane

(71) Applicant: New Jersey Institute of Technology, Newark, NJ (US)

(72) Inventors: Wen Zhang, Livingston, NJ (US); Weihua Qing, Kearny, NJ (US)

(73) Assignee: New Jersey Institute of Technology, Newark, NJ (US)

(21) Appl. No.: 17/485,932

(22) Filed: Sep. 27, 2021

Related U.S. Application Data
(60) Provisional application No. 63/087,951, filed on Oct. 6, 2020.

(51) Int. Cl. B01D 61/36; B01D 69/02; B01D 8/00; B01D 69/10; B01D 69/12

(52) U.S. Cl. CPC B01D 61/362; B01D 69/02; B01D 8/00; B01D 2313/22; B01D 69/12; B01D 2325/46; B01D 69/10

(57) ABSTRACT

A pervaporation apparatus and method for liquid mixture separation are disclosed. The pervaporation disclosed utilizes an interfacial-heating membrane utilizing induction heating to provide temperature differences across the membrane for driving liquid mixture separation. The pervaporation system may include an electromagnetic induction heating device that is placed close to or encapsulated in a membrane module wherein one or more membranes with surfaces containing ferromagnetic or other induction-responsive materials. The membrane surface generates localized heat owing to the presence of a ferromagnetic composition that converts electric energy from an induction source to thermal energy. The ferromagnetic composition could include, without limitation, metals, metal alloys, composite materials, nanocomposite materials, nanoparticles, meshes, and combinations thereof.

### CROSS-REFERENCE TO RELATED APPLICATIONS

This application claims the benefit of the filing date of U.S. Provisional Patent Application No. 63/087,951, filed Oct. 6, 2020, the disclosure of which is hereby incorporated herein by reference.

### STATEMENT REGARDING FEDERALLY SPONSORED RESEARCH

This invention was made with government support under Agreement No. R19AC00107 awarded by the U.S. Department of the Interior via the Bureau of Reclamation. The government has certain rights in the invention.

### FIELD OF THE DISCLOSURE

The present disclosure relates to liquid mixture separation by a membrane. In particular, the present disclosure relates to an apparatus and method to provide localized induction heating on a ferromagnetic material-coated membrane to achieve efficient liquid mixture separation by pervaporation.

### BACKGROUND OF THE INVENTION

The use of liquid mixtures containing compounds, such as organic compounds, occur throughout various industries. Pervaporation (PV) is a membrane separation process used on liquid mixtures that is a relevant part of processing in environmental, biotechnological, food, petrochemical, chemical, and pharmaceutical industries. Pervaporation separates liquids mixtures by partial vaporization through a non-porous membrane. Typically, the driving force is provided by a chemical potential difference between the liquid feed and vapor permeate at each side of the membrane.

Pervaporation is especially attractive for separation of mixtures that are difficult to separate by distillation. Pervaporation has advantages in the separation of thermally sensitive compounds, close-boiling mixtures, azeotrope mixtures, molecules with similar weight or shape, and removing species present in low concentrations. Separation of components is based on a difference in solubility and diffusion rate of individual components in the membrane.

Compared to other conventional separation processes, pervaporation has the advantages of high separation efficiency and mild operating conditions. Much research into pervaporation processes has been done over the past decades in both the laboratory and in commercial use. However, despite this wealth of research, both in the laboratory and in plant scales, pervaporation processes that are technically and economically competitive with distillation have not been available to date.

Even though energy requirement for pervaporation is lower compared to distillation, continuous external heating of the entire bulk feed streams is required in order to maintain the desired temperature gradient between the two membrane sides to drive effective molecular separation. The cost of bulk feed stream heating is a major contributor to the total cost of a pervaporation process. To make it worse, this conventional heating method inevitably cause unfavorable temperature polarization at the membrane-liquid interface, leading to a decreased thermal efficiency and thus a compromised separation permeability. In conventional heating by either a heating plate or a heat exchanger, the heat transfer reduces the temperature difference across the membrane, resulting in a lower permeate flux across the membrane and thus a lower pervaporation efficiency. Other drawbacks of the conventional heating method include inefficient thermal transfer, the need for heating the entire feed solution, high heating energy consumption and heat loss. This temperature difference or thermal gradient further decreases along the flow direction of the membrane module (e.g., in a cross-flow mode), resulting in a maximal usable length of a single module.

Recent research adopted localized heating with limited success. Localized heating at the feed/membrane interface provides enhanced energy efficiency. It eliminates the requirement of heating the entire input feed stream and reduces the demand for hot feed or the cost to maintain hot feed. It also eliminates the intrinsic temperature polarization existing in the conventional pervaporation process for improved thermal efficiency. The elevated membrane/liquid interfacial temperature enhances the component diffusion coefficient, and potentially increases separation permeability. However, these recent attempts have encountered many drawbacks.

For example, in a recent study a silver nanoparticle had an incorporated polydimethylsiloxane (PDMS) membrane that enhanced ethanol flux and selectivity for water/ethanol separation performance under LED light irradiation. However, the localized heating enabled by light activated or photo-thermal heating is restricted to flat sheet membranes that have low membrane packing density and thus have a potentially high footprint. Moreover, regardless of the use of artificial illumination sources (e.g., LED) or solar irradiation, the heat loss due to the absorption of light energy by the feed liquid is inevitable. In another study that utilized localized heating employed was a microwave to heat the ethanol/water solution for pervaporational separation. However, this method also targeted at the entire feed solution for heating, instead of the membrane-liquid interface, therefore the undesired temperature polarization still negatively affects the separation permeability.

As such, there is a need for effective surface heating methods and integrated systems for pervaporational separation. In this regard, it is important to develop alternative heating methods in a process that enhances heat and mass transfer with low energy consumption.

### BRIEF SUMMARY OF THE INVENTION

Disclosed is a newly developed pervaporation system and process that utilizes induction heating in a localized heating manner. Compared to the above prior attempts, the presently disclosed apparatus and method solves the problems of current state of the art, meets the above requirements, and provides many more benefits.

The induction heating process efficiently delivers localized heating on the induction-responsive materials, such as but not limited to ferromagnetic Fe₃O₄ (Iron(II,III) oxide) nanoparticles, embedded within the selective layer of the pervaporation membrane, or coated on the surface layer of the pervaporation membrane. It will be understood that other induction-responsive materials could be employed. Typically, induction heating involves the heating of a material by inducing an electric current or electron eddy within it. No light or photo-thermal heating is involved in the induction heating and therefore all the drawbacks of the photo-thermal heating technology is avoided. Provided is a pervaporation (PV) system and method that incorporates ferromagnetic materials into the membrane structure and utilizes induction heating as a driving force, which provides unexpectedly enhanced thermal efficiency and separation permeability. This apparatus and process are based on the highly efficient and localized induction heating induced by the ferromagnetic materials, such as the above mentioned Fe₃O₄ nanoparticles (NPs). The ferromagnetic nanoparticles are embedded within the surface layer of the PV membrane. The localized heating induces in-situ temperature enhancement of the liquid membrane interface. Thus, the enthalpy of evaporation pervaporation can be supplied directly at the membrane surface where the evaporation takes place. This in-situ heating method not only eliminates the intrinsic temperature polarization existed in the conventional PV process but also enhance the component diffusion coefficient, and thus simultaneously improve the thermal efficiency and separation permeability. The localized induction heating process avoids the requirement to heat the entire volume of feed liquid by external means, thus eliminating the substantial power requirements and inherent efficiency limitations of the conventional PV process.

Depending on the embodiment, a PV separation apparatus includes a membrane separation module, an influent side, and permeate side, a membrane, and an induction heating device. During the operation process of the invention, the feed liquid stored in the storage tank is pumped into the influent side of the membrane module by a liquid circulating pump. The feed liquid in the influent side in the membrane module is heated by an induction-responsive membrane that absorb an externally applied electromagnetic induction waves, resulting in promoted driving force for PV separation. In other arrangements, the permeate side in the membrane module may maintain a vacuum by a cascade of a cold trap and a vacuum pump. The cold trap may include, but is not limited to, the following selected from a group consisting of a liquid nitrogen, a dry ice, a dry ice in acetone or a solvent with a boiling point between 40° C.-95° C., or any combination thereof.

The temperature difference and partial vapor pressure difference between the feed side and permeate side cause the liquid components to pass through the functionalized membrane in the present invention. Here, the functionalized membrane can be either hydrophobic or hydrophilic, depending on the hydrophobicity of target separation components, and the target component will be concentrated at the permeate side due to higher selectivity of the membrane towards the target component, and is finally collected in the cold trap.

Depending on the embodiment, an induction-assisted pervaporation apparatus and an interfacial-heating pervaporation membrane module for liquid mixture separation may include an interfacial-heating/separation dual functional pervaporation membrane that incorporates induction-responsive materials into the structure of a conventional pervaporation membrane and utilizes induction heating as the liquid separation driving force. The induction-responsive materials in the pervaporation membrane are in situ excited under an electromagnetic field that is typically characterized by induction field power and field shift frequency. These characteristics of the electromagnetic field is tunable by adjusting the applied electricity, the induction coil shapes or sizes and the membrane-coil distance.

Electromagnetic induction heating provides contactless, fast, efficient, and accurately controlled heating of conductive or ferromagnetic materials that could locally be coated on or blended within the membrane materials. The induction heating is driven by the formation of eddy currents and magnetic polarization effects, when ferromagnetic and conductive materials are exposed to an alternating current electromagnetic field. Since the induction heating is dependent on the conductive and magnetic properties of the material to be heated, the heating process could be made selectively toward specific target materials or regions of the materials without the loss of energy to water heating or others. Various applications of induction heating have been demonstrated, including industrial processes (e.g., forging, melting, welding and annealing), kitchen cooking, and medical applications (e.g., minimally-invasive therapies, sterilization of surgical instruments).

In another implementation, the material of the pervaporation polymer membrane includes, but not limited to, poly(vinyl alcohol), chitosan, cellulose, polydimethylsiloxane, poly(ether amide), poly(1-trimethylsilyl-1-propyne), zeolites, metal-organic frameworks, and any combinations thereof. This is applicable to a wide range of membranes that may be flat, hollow fiber, or tubular.

The membrane could include a hybrid self-heating and separation bifunctional layer and a support layer. In another embodiment, the membrane could include a self-heating layer, the separation layer, and the support layer. In one embodiment, the induction-responsive materials are either incorporated into the selective layer (the separation layer) or coated on the top of the selective layer in the dual functional pervaporation membranes.

Furthermore, the induction-responsive materials-coated interfacial-heating layer can generate heat when exposed to the electromagnetic field. Depending on the embodiment, the induction-responsive materials-coated interfacial-heating layer is associated on the selective layer through cross-linking, coating, grafting, embedding, or other kinds of binding methods such as but not limited to where the induction-responsive materials are disposed in the polymer membrane through cross-linking, surface coating, blending, grafting, or any combination thereof.

The induction-responsive materials-coated interfacial-heating layer is associated on the selective layer through at least one of hydrogen bonds, van der Waals interactions, electrical interactions, and combinations thereof. In addition, the induction-responsive materials include, but not limited to, iron, metal, metal alloys, Fe₃O₄ nanoparticles, or other ferromagnetic and conductive materials, and a group consisting of iron, metal, metal alloys and their oxides or compounds, Fe₃O₄ (Iron(II,III) oxide) nanoparticles, Fe₂O₃ (ferric oxide) nanoparticles, MXene (a ceramic of two dimensional inorganic compounds), ferromagnetic and conductive materials, and any combinations thereof.

The induction-responsive materials in the dual functional pervaporation membrane capable of generating heat may include particles, nanoparticles, composites, or any combination thereof.

In one aspect, a method involves exposing the induction-responsive materials-coated interfacial-heating layer to an electromagnetic field at different frequencies of 0.1 kHz-500 kHz and power supply of 0.1-10 KWh. Further, the electromagnetic field can be provided by single or multiple induction devices or sources. The dual functional membrane can be heated periodically or continuously.

In another aspect, a pervaporation system for liquid mixture separation comprises simultaneous heating and separation of liquid mixture through a dual functional composite membrane to achieve interfacial heating and separation. The dual functional membrane comprises a functionalization capable of generating heat under electromagnetic induction. The heat generated on the surface enhances the separation permeability.

Any combination and/or permutation of the embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the disclosed pervaporation system and method and associated systems and methods, reference is made to the accompanying figures, wherein:

FIG. 1 is a schematic diagram of an electromagnetic induction pervaporation system, in accordance with one embodiment of the present disclosure;

FIG. 2 illustrates liquid mixture separation under induction heating; and,

FIGS. 3A and 3B are diagrams showing the structures of the interfacial-heating/separation dual functional pervaporation membranes in which the induction-responsive materials are blended into the selective layer of the membrane (FIG. 3A) or the induction-responsive materials are coated on the top of the selective layer of the membrane (FIG. 3B).

### DETAILED DESCRIPTION

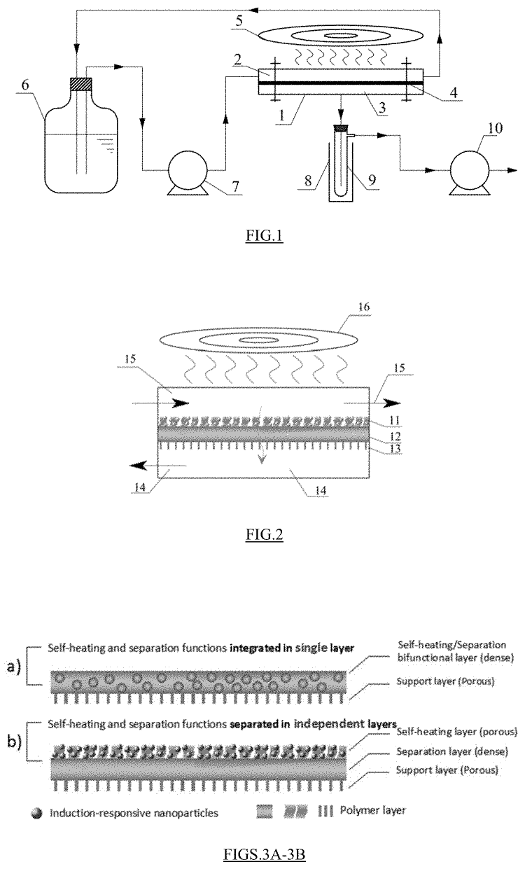

Adverting to the drawings, FIG. 1 is a schematic diagram of one embodiment of an electromagnetic induction pervaporation system comprising a membrane separation module 1 for the liquid mixture separation, an influent side 2, and a permeate side 3, an interfacial-heating/separation dual functional membrane 4 for separation, and an induction heating device 5. The pervaporation system could comprise a raw feed storage tank 6, a raw feed circulating pump 7, a liquid nitrogen cold trap 8, a permeate collecting tube 9, and a vacuum pump 10.

During a typical operation, the raw feed stored in the raw feed storage tank 6 is pumped into the influent side 2 of the membrane module 1 by the raw feed circulating pump 7. The raw feed in the influent side 2 in the membrane module 1 of the present invention contacts the locally heated membrane surface under an electromagnetic induction, resulting in the heating of interfacial liquid in the raw feed. Meanwhile, the permeate side 3 in the membrane module 1 in the present embodiment is maintained a high vacuum (4-5 kPa) by a cascade of the liquid nitrogen cold trap 8, the permeate collecting tube 9, and the vacuum pump 10. The purified components from the permeate side 3 is condensed in the liquid nitrogen cold trap 8 and collected periodically from the permeate collecting tube 9.

The temperature difference and vapor pressure difference between the influent side 2 and the permeate side 3 cause the liquid component to permeate through the functional membrane 4 in the present embodiment. The functional membrane 4 will be described in detail in FIG. 2.

FIG. 2 is a detailed illustration of one embodiment of a mass transfer process within the membrane module 1. In this embodiment, the membrane module 1 could comprise an interfacial-heating/separation dual functional composite membrane, which includes three different layers. The top layer is a porous or non-porous interfacial-heating layer 11, which is induction-responsive and can be heated under an electromagnetic field 16. Depending on the embodiment 16 may be one or more electromagnetic field (EMF) device(s) also known as induction heating source(s). These EMF devices, include but are not limited to thermoelectric devices, electrochemical cells, photodiodes, solar cells, electrical generators, transformers, and Van de Graaff generators. In addition, the EMF may be amplified using various devices, such as but not limited to magnetic amplifier (mag amp), transistor amplifier and the like. Magnetic amplifiers have largely been superseded by the transistor-based amplifier, except in a few critical, high-reliability or extremely demanding applications. Combinations of transistor and mag-amp techniques may still be used.

The middle layer of the membrane is a dense pervaporational separation layer 12, which has perm-selectivity for the feed stream at the influent side 15. The bottom layer is a porous support layer 13 providing mechanical support for the top two layers. The localized heating generated at the interfacial-heating layer 11 promotes the solubility and diffusion of the influent feed 15 in the separation layer 12 and converts to a vapor at the permeate side 14 where a vacuum is maintained. The vapor flows through the channel 14 and is then condensed and collected in the tube 9 shown in FIG. 1.

FIGS. 3A-3B are diagrams showing the structures of the interfacial-heating/separation dual functional pervaporation membranes in which the induction-responsive materials are either blended into the selective layer of the membrane (FIG. 3A) or the induction-responsive materials are coated on the top of the selective layer of the membrane (FIG. 3B). Depending on the embodiment, the induction responsive materials include, but are not limited to, a group consisting of iron, metal, metal alloys and their oxides or compounds, Fe₃O₄ (Iron(II,III) oxide) nanoparticles, Fe₂O₃ (ferric oxide) nanoparticles, MXene (a ceramic of two dimensional inorganic compounds), ferromagnetic and conductive materials, and any combinations thereof.

In the embodiment shown in FIG. 3A, the membrane module 1 could comprise an interfacial-heating/separation dual functional composite membrane, which includes two different layers. The top layer is a hybrid porous interfacial-heating and dense pervaporational separation layer, and the bottom layer is a porous support layer providing mechanical support for the top layer. Depending on the implementation, the top layer may have a porosity between about 20-90%. Porosity is defined in this disclosure as a void or void fraction. Porosity is a measure of the void (i.e., “empty”) spaces in a material, and is a fraction of the volume of voids over the total volume, between 0 and 1, or as a percentage between 0% and 100%. In addition, depending on the implementation, the top layer may include a shape selected from a group consisting of a flat sheet, a cylinder, a cone, a rectangular, a sphere, an irregular shape, and any combinations thereof.

The materials and the methods of the present disclosure used in examples will be described below. While the examples discuss the use of specific compounds and materials, it is understood that the present disclosure could employ other suitable compounds or materials. Similar quantities or measurements may be substituted without altering the method embodied below.

### Example 1

First, Fe₃O₄ nanoparticles are synthesized by a modified chemical co-precipitation method. Briefly, 0.99 g FeCl₂.4H₂O and 2.7 g FeCl₃.6H₂O are dissolved in 100 ml deionized water in a 250 ml flask with mechanical stirring under nitrogen atmosphere at 80° C.

Then 10 mL NH₃.H₂O 25% (v %) is dropped at a speed of 1 drop per second into the above solution. The mixture is stirred continuously for 30 min. The obtained black Fe₃O₄ is washed with deionized water and ethanol under magnetic field and dried in the vacuum oven.

Subsequently, Polyvinyl alcohol (PVA) powder is first dissolved in deionized (DI) water at 90° C. for at least 6 h to obtain a 2 wt. % PVA casting solution. Then, a cross-linking agent of maleic acid (mole ratio of maleic acid:PVA=0.05:1) is added to the PVA solution and further stirred at 90° C. for 12 h. Subsequently, Fe₃O₄ nanoparticles is added into the PVA casting solution and stir vigorously to obtain a Fe₃O₄/PVA casting suspension.

The concentrations of PVA and Fe₃O₄ in the resultant casting solution are both around 5 wt. %, respectively.

Afterwards, the casting suspension is carefully cast on a polyethersulfone (PES) support layer by a casting knife at a casting gate height of 50 and then dried at room temperature overnight to obtain the hybrid Fe₃O₄/PVA dual functional membrane, whose structure is shown in FIG. 3A.

### Example 2

First, Fe₃O₄ nanoparticles were synthesized according to EXAMPLE 1 herein. Then, a PVA/PES membrane was prepared using the following steps: first, a 2 wt. % PVA aqueous solution is prepared by vigorously stirring PVA (polyvinyl alcohol) power in DI (deionized) water at 90° C. for 6 h. Then, the PVA solution is crosslinked by adding a maleic acid (a mole ratio of maleic acid:PVA=0.05:1) for another 12 h at 90° C. Afterwards, the PVA solution is poured into a rectangular container and the PES (polyethersulfone) porous membrane is dipped onto the PVA solution for 5 min and then taken out for drying in room temperature. Four dip-coating cycles are performed, and the resultant PVA/PES pervaporation membrane is dried overnight at room temperature. At the last step, the dried PVA/PES membrane is further cured in an air dry oven at 120° C. for 1 h to ensure complete crosslinking between the maleic acid with the PVA chain.

Subsequently, an interfacial-heating layer is coated through phase inversion method on the PVA/PES membrane prepared above: first, a Fe₃O₄/PVA casting mixture is first prepared by dispersing Fe₃O₄ (iron (II,III) oxide) nanoparticles in Milli-Q water under mechanical agitation, which is then added into a crosslinking-treated PVA aqueous solution. The concentrations of PVA and Fe₃O₄ in the casting mixture are 5 wt. % and 25 wt. %, respectively. Then, the casting mixture is carefully cast on the PVA/PES membrane by a casting knife with a casting gate height of 250 μm. The resultant membrane is immediately immersed into an ethanol coagulation bath at room temperature. After complete solidification, the membrane is taken out and dried at room temperature to obtain the composite multi-layer Fe₃O₄/PVA dual functional membrane, whose structure is shown in FIG. 3B.

### Example 3

In this example, the inventors assessed the desalination performance of interfacial-heating/separation dual functional composite membranes by utilizing the bench scale system shown in FIG. 1. In specific, the bench top pervaporation unit has a pervaporation membrane module with an effective membrane diameter of 35 mm and a separation area of approximately 10 cm². The module housing was made from acrylic glass and was placed on a commercial induction heating station. The interracial-heating and separation dual functional membrane prepared in EXAMPLE 2 was sealed in the middle of the module. The feed solution of synthetic seater of 3.5 wt. % NaCl water was circulated through the feed channel of modules at a flow velocity of 5 cm·min⁻¹. At the permeate channel, vacuum (4-5 kPa) was maintained by a cascade of a liquid nitrogen cold trap and a vacuum pump. The inlet temperatures at the feed were constantly maintained at 20±0.5° C. throughout the entire experiment. The induction heating system was operated at a frequency of 162 kHz and power supply of 5 kW. Any experiment under given conditions was pre-run for around 3 hours after steady state was reached. Finally, the permeate was collected periodically at the cold trap to calculate the salt rejection and water flux. The salt rejection was measured to be 99.9%, and the water flux was measured to be 2 kg·m⁻²·h⁻¹.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

What is claimed is:

1. A pervaporation system for liquid mixture separation, comprising:
an interfacial-heating and separating dual functional composite membrane for simultaneously heating and separating a liquid mixture therethrough; and
wherein the dual functional composite membrane generates a localized heat on a surface of the membrane when exposed to electromagnetic induction, and the heat generated on the surface enhances separation permeability.

2. The system of claim 1, wherein the interfacial-heating and separating dual functional composite membrane is a composite membrane that further includes:
a top layer having a porous or non-porous interfacial-heating layer;
a middle layer having a dense pervaporational separation layer; and
a bottom layer having a porous support layer.

3. The system of claim 2, wherein the top layer contains an induction-responsive material or an induction-responsive material incorporated in a polymer membrane.

4. The system of claim 3, wherein the top layer when exposed to an electromagnetic field or an induction field generates heat by converting electric energy from an induction heating source to thermal energy.

5. The system of claim 4, wherein the electromagnetic field is amplified.

6. The system of claim 4, wherein the induction field is provided by a single induction heating source or multiple induction heating sources.

7. The system of claim 3, wherein the top layer is porous and has porosities ranging from 20%-90%, and has pore sizes between 0.05 μm to 5 μm.

8. The system of claim 3, wherein the top layer has a shape selected from a group consisting of a flat sheet, a cylinder, a cone, a rectangular, a sphere, an irregular shape, and any combinations thereof.

9. The system of claim 3, wherein the induction-responsive materials are selected from a group consisting of iron, metal, metal alloys and their oxides or compounds, Fe₃O₄ (Iron(II,III) oxide) nanoparticles, Fe₂O₃ (ferric oxide) nanoparticles, MXene (a ceramic of two dimensional inorganic compounds), ferromagnetic and conductive materials, and any combinations thereof.

10. The system of claim 3, wherein the polymer membrane is selected from a group consisting of poly(vinyl alcohol), chitosan, cellulose, polyaniline, polydimethylsiloxane, poly(ether amide), poly(l-trimethylsilyl-1-propyne), and any combination thereof.

11. The system of claim 3, wherein the induction-responsive materials are disposed in the polymer membrane through cross-linking, or coating, or blending, or grafting, or any combination thereof.

12. The system of claim 2, wherein the middle dense pervaporational separation layer is a material selected from a group consisting of poly(vinyl alcohol), chitosan, cellulose, polydimethylsiloxane, poly(ether amide), poly(l-trimethylsilyl-1-propyne), alumina, zeolites, metal-organic frameworks, and any combinations thereof.

13. The system of claim 2, wherein the bottom porous support layer is a material selected from a group consisting of polyvinylidene difluoride, polysulfones, polytetrafluoroethylene, poly(vinyl alcohol), chitosan, cellulose, polydimethylsiloxane, poly(ether amide), poly(l-trimethylsilyl-1-propyne), alumina, zeolites, and any combinations thereof.

14. The system of claim 2, wherein the porous membrane contains flat, tubular, or hollow fibers.

15. A pervaporation system for liquid mixture separation, comprising:
a composite membrane separation module having an influent side, a permeate side, and a membrane, and wherein the membrane separation module contains an electromagnetic material;
an induction heating device for heating the electromagnetic material in a localized area by inducing an electric current within the electromagnetic material; and
wherein heat is generated on a surface of the composite membrane module to enhance solubility and diffusion of feed components to enhance permeability.

16. The system of claim 15, wherein the electromagnetic material is selected from a group consisting of iron, metal, metal alloys, Fe₃O₄ nanoparticles, Fe₂O₃ nanoparticles, MXene (a ceramic of two dimensional inorganic compounds), ferromagnetic and conductive materials, and any combinations thereof.

17. A method of using a pervaporation system for liquid mixture separation, comprising
providing an interfacial-heating and separating dual functional composite membrane for simultaneously heating and separating a liquid mixture therethrough, the membrane having an induction-responsive material-coated interfacial-heating layer;
exposing the induction-responsive material-coated interfacial-heating layer to an electromagnetic field or induction by an induction heating device at frequencies between about 0.1 kHz-500 kHz and power supply between about 0.1-10 KWh;
pumping by a liquid circulating pump a feed liquid stored in a storage tank into an influent side of the membrane;
heating the feed liquid in the influent side in the membrane by the induction heating device, resulting in a promoted driving force for pervaporation separation; and
wherein the heating generates a localized heat on a surface of the membrane when exposed to the electromagnetic field or induction wherein the dual functional composite membrane, and the heat generated on the surface enhances separation permeability.

18. The method of claim 17, further includes:
maintaining, in a permeate side in the membrane, a vacuum by a cascade of a cold trap and a vacuum pump;
creating a temperature difference and a partial vapor pressure difference between the influent side and the permeate side to cause liquid components to pass through a dense layer of the membrane, wherein the dense layer is either a hydrophobic layer or a hydrophilic layer depending on hydrophobicity of a target separation component;
concentrating the target separation component at the permeate side due to higher selectivity of the membrane towards the target separation component; and
collecting the target separation component in the cold trap.

19. The method of claim 17, wherein the dual functional membrane is heated periodically or continuously.

20. The method of claim 18, wherein the cold trap is selected from a group consisting of a liquid nitrogen, a dry ice, a dry ice in acetone or a solvent with a boiling point between 40° C.-95° C., or any combination thereof.
